(19) United States
(12) Patent Application Publication
(10) Pub. No.: US 2008/0264750 A1
(43) Pub. Date: Oct. 30, 2008

(54) STARTING CLUTCH APPARTUS

(75) Inventor: Masaki SAKAI, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-Warner K.K.

(21) Appl. No.: 12/107,056

(22) Filed: Apr. 21, 2008

(30) Foreign Application Priority Data
Apr. 27, 2007 (JP) 2007-119439

(51) Int. Cl. F16D 13/74

(52) U.S. Cl. 192/70.12

(57) ABSTRACT

The present invention provides a starting clutch apparatus disposed between a transmission and an engine of a vehicle and including a wet type multi-plate clutch for transmitting a power, in which the starting clutch apparatus includes a starting clutch having a clutch drum within which the wet type multi-plate clutch is housed and a damper device engaged by the clutch drum, and grease of urea group is contained in the damper device.

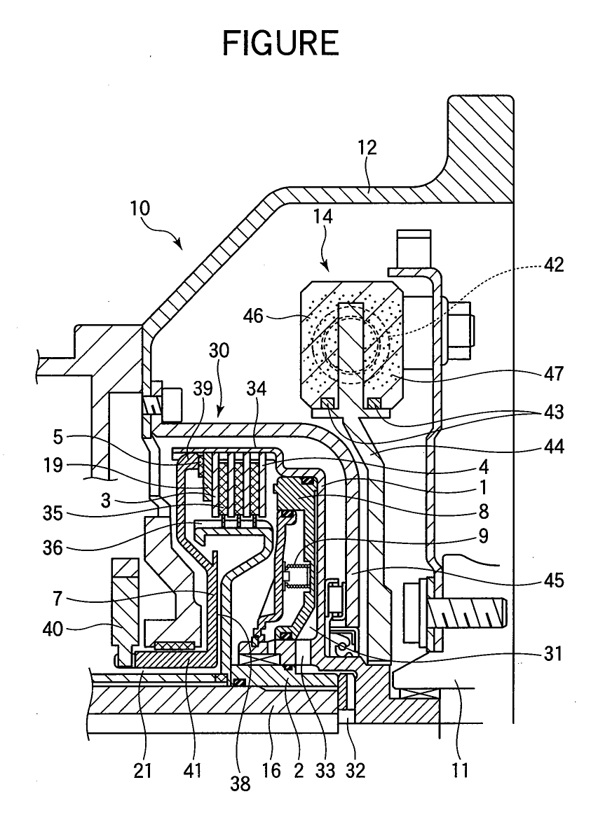

### BACKGROUND OF THE INVENTION

1. Field of the Invention

The present invention relates to a starting clutch apparatus utilizing a wet type multi-plate clutch used in an automobile and the like. More specifically, the present invention relates to a starting clutch apparatus in which grease of urea group is contained in a damper device of the starting clutch apparatus.

2. Description of the Related Art

In the prior arts, in automatic transmissions i.e. ATs, the starting of a vehicle was performed by torque transmission in a torque converter. Since the torque converter not only has a torque amplifying ability but also can transmit the torque smoothly, the torque converter has been mounted on many AT vehicles.

On the other hand, the torque converter has a disadvantage that high efficiency cannot be achieved because of a large amount of slip during the torque transmission.

Thus, in recent years, it has been proposed to use a starting clutch in place of the torque converter, and the torque has been amplified at a low speed rage by reducing a gear ratio and increasing speed change stages.

In general, the starting clutch includes a wet type multi-plate clutch housed in a clutch drum. In the multi-plate clutch, friction plates as friction engaging elements at an output side and separator plates as friction engaging elements at an input side are alternately arranged along an axial direction. With this arrangement, by engaging the separator plates with the friction plates by means of a piston, a power is transmitted.

The starting clutch apparatus utilizing the wet type multi-plate clutch can be mounted on the vehicle in place of the torque converter. By providing the starting clutch apparatus, energy loss, which would be generated when the torque is transmitted via fluid as in the torque converter, can be eliminated, and excellent reduction in fuel consumption can be achieved.

However, in the torque converter, at the low speed condition, since the torque is transmitted from the engine via the fluid, vibration of the engine can be absorbed; but, the starting clutch apparatus utilizing the wet type multi-plate clutch cannot absorb such vibration of the engine. Thus, a damper device must be provided to absorb the vibration from the engine.

As mentioned above, although the starting clutch apparatus including the damper device has the excellent performance, the starting clutch apparatus causes the following problem. In general, although the damper device has a spring (refer to a torsion damper 6 shown in FIGURE of Japanese Patent Application Laid-open No. 2004-324818), in order to enhance the vibration damping function, a displacement angle of the spring must be increased. To this end, displacement angles at a drive side and a driven side are increased by increasing a length of the spring or by connecting a plurality of springs in series with the interposition of sliders or by increasing a distance between the drive side and the driven side. However, in this arrangement, since a sliding distance between a damper cover at the drive side and the springs and the sliders becomes great, there arises a problem that the springs and/or sliders and/or damper cover may be worn.

### SUMMARY OF THE INVENTION

Accordingly, an object of the present invention is a starting clutch apparatus including a damper device, in which wear of the damper device and constructional elements of the damper device can be prevented and influence of engine vibration can be suppressed.

To achieve the above object, the present invention provides a starting clutch apparatus disposed between a transmission and an engine of a vehicle and including a wet type multi-plate clutch for transmitting a power, in which the starting clutch apparatus includes a starting clutch having a clutch drum within which the wet type multi-plate clutch is housed and a damper device engaged by the clutch drum, and grease of urea group including organic compound of urea group as a growing agent is contained in the damper device.

According to the starting clutch apparatus of the present invention, the following effects can be obtained.

Since the grease of urea group is contained in the damper device, wear of parts of the damper device can be prevented effectively.

Further, the grease of urea group has the excellent growing ability and heat resistance and is hard to be softened even under a high temperature condition and also has a long service life. Thus, the wear of the damper device can be prevented effectively.

When organic compound of urea group is used as the growing agent, an anti-wear property is enhanced.

Further, in general, in many cases, the damper device is arranged between the engine and the starting clutch and is disposed exterior of a main body of the starting clutch in consideration of a degree of freedom of design and facilitation of maintenance and manufacture. In such a circumstance, the damper device is situated in a very high temperature environment generated by heat from the engine and the starting clutch. However, as is in the present invention, by containing the grease of urea group in the damper device, the problem regarding the wear of the damper device can be solved.

Further features of the present invention will become apparent from the following description of exemplary embodiments with reference to the attached drawing.

### BRIEF DESCRIPTION OF THE DRAWINGS

FIGURE is an axial sectional view showing a starting clutch apparatus according to an embodiment of the present invention.

### DESCRIPTION OF THE EMBODIMENTS

Now, an embodiment of the present invention will be fully described with reference to the accompanying drawing. Incidentally, the embodiment described hereinbelow is merely an example of the present invention and it should be noted that many alterations can be made.

FIGURE is an axial sectional view of a starting clutch, for explaining a lubrication controlling method and a lubrication controlling apparatus for a starting clutch according to the present invention. The starting clutch 10 comprises a clutch drum or clutch case 1, and a wet type multi-plate clutch 30 housed in the clutch case. In the wet type multi-clutch 30, substantially annular friction plates 3 as friction engaging elements at an output side and substantially annular separator plates 4 as friction engaging elements at an input side are alternately disposed along an axial direction within the clutch case 1. At an axial one end or open end of the clutch case 1, a substantially annular backing plate 19 is fixedly supported by a substantially annular stop ring 5 in the axial direction to hold the separator plate 4.

The annular clutch case 1 is provided at its outer periphery with a drum portion 34. The drum portion 34 is provided at its inner periphery with a spline portion 39 with which the separator plates 4 are engaged for an axial sliding movement.

In the illustrated embodiment, although the wet type multi-plate clutch 30 is constituted by three friction plates 3 and three separator plate 4, it should be noted that the number of these friction engaging elements at the input and output sides can be changed in accordance with the required torque. Further, substantially annular friction materials 35 or plural friction material segments 35 are secured to both surface of the friction plate 3 by an adhesive or the like. Further, the friction materials may be secured to the separator plates or friction materials 35 may be secured to one of surfaces of the friction plates 3 and the separator plates 4 alternately.

In FIGURE, a piston 8 is provided within a closed end portion of the clutch case 1. The piston 8 is mounted within the clutch case 1 for an axial sliding movement so that the piston can abut against the separator plate 4 to apply an urging force to the separator plate.

A hydraulic chamber 31 is defined between the piston 8 and an inner surface of the clutch case 1, which hydraulic chamber is maintained in an oil-tight condition by two O-rings. By supplying hydraulic oil from an oil path (described later) to the hydraulic chamber 31, the shifting movement of the piston 8 is controlled, thereby applying a predetermined urging force to the piston 8. A spring 9 for always biasing the piston 8 toward the hydraulic chamber 31 in a clutch released condition is provided at a side of the piston opposite to the hydraulic chamber 31.

When predetermined hydraulic pressure is supplied to the hydraulic chamber 31, the piston 8 is shifted to the left in FIGURE, thereby tightening the wet type multi-plate 30 between the piston and the backing plate 19. The oil id flown from a lubricating oil supplying source to the hydraulic chamber 31 through an inner port provided in an output shaft 16, a clearance 32 defined between the clutch case 1 and an axial end of the output shaft 16 and a through-hole 33 provided in an inner periphery cylindrical portion of the clutch case 1.

The friction plate 3 of the wet type multi-plate clutch 30 is provided with grooves (not shown), and each groove is formed to have a depth substantially the same as a thickness of the friction material 35 and a circumferential width greater than 3 mm. With this arrangement, a cooling effect is enhanced even in the engagement condition of the starting clutch 10 which is hard to be cooled.

A hub member 2 fitted on the output shaft 16 to be rotated integrally with the output shaft 16 of the transmission is provided at its outer periphery with a spline portion 36. The friction plates 3 are mounted to the spline portion 36 for an axial sliding movement. Accordingly, a power inputted from a crank shaft (not shown) is transmitted to the transmission (not shown) via a housing 12 and through a damper device 14 (described later), clutch case 1, wet type multi-plate clutch 30, hub member 2 and output shaft 16.

The damper device 14 as a shock absorbing mechanism for absorbing vibration of the engine and shock generated upon the engagement of the clutch is connected to the clutch case 1 of the wet type multi-plate clutch 30. The damper device 14 includes a spring 42 and a retainer plate 44 for holding the spring.

Grease 47 of urea group is contained within the damper device 14. It is preferable that organic compound of urea group as a growing agent is mixed with the grease 47 of urea group. In the embodiment of the present invention, for example, “Piloknock Universal 0” (trade mark) manufactured by Shin-Nippon Sekiyu Co., Ltd. (Japan) may be used as the grease of urea group. Further, aliphatic, alicyclic or aromatic organic compound of urea group may be used.

The drive plate or retainer plate 44 of the damper device 14 is engaged by the clutch case 1 so that the power from the engine (not shown) is inputted to the clutch case 1 via the retainer plate 44.

As mentioned above, the damper device 14 includes the spring 42. The spring 42 may be a torsion spring of coil type and is preferably of long travel type having a great displacement angle.

The starting clutch 10 has a cover 45 and the damper device 14 is disposed outside the cover 45. Accordingly, the damper device 14 is exposed to a high temperature environment generated by heat from the engine (not shown) and the starting clutch 10. However, by using the grease 47 of urea group in the damper device 14, problems regarding the wear and the high temperature can be solved simultaneously.

As shown in FIGURE, in the damper device 14, in order to seal the damper device 14 in a sealed condition, as a leakage preventing means for preventing the grease 47 of urea group from leaking out of the damper device 14, a seal member 43 is provided between a housing 46 and the retainer plate 44. Further, in order to seal the damper device 14 in which a plurality of springs 42 and a plurality of slider members between the springs are provided in the annular damper device, it is preferable that a plurality of seal members 43 are used. The seal member 43 may be an O-ring or the like.

At one axial end, the output shaft 16 is provided at its outer periphery with a spline portion with which the hub member 2 is engaged. Accordingly, the output shaft 16 and the hub member 2 are rotated integrally with each other.

A cover member 7 is provided an open end portion of the clutch case 1. An outer diameter edge portion of the cover member 7 is fitted in a spline portion 39 of the clutch case 1. Thus, the cover member 7 is rotated together with the clutch case 1. A narrow lubricating oil passage 38 is defined between the cover member 7 and the hub member 2. As can be seen from FIGURE, by providing the cover member 7, the wet type multi-plate clutch 30 is disposed in a substantially closed space.

An inner diameter portion 41 of the cover member 7 is engaged by an oil pump 40 to be driven by the rotation of the cover member 7 so that, when the oil pump is driven, the lubricating oil is supplied to the starting clutch 10 through a clearance 21 between the inner diameter portion 41 and the shaft 16 and the passage or clearance 38 between the cover member 7 and the hub member 2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-119439, filed on Apr. 27, 2007, which is hereby incorporated by reference herein in its entirety.

What is claimed is:

1. A starting clutch apparatus disposed between a transmission and an engine of a vehicle and including a wet type multi-plate clutch for transmitting a power, comprising:
a starting clutch having a clutch drum within which said wet type multi-plate clutch is housed; and
a damper device engaged by said clutch drum;
and wherein
grease of urea group is contained in said damper device.

2. A starting clutch apparatus according to claim 1, wherein the grease of urea group includes organic compound of urea group as a growing agent.

3. A starting clutch apparatus according to claim 1, wherein said damper device includes a drive plate engaged by said clutch drum, so that a power from said engine is inputted from a crank shaft to said clutch drum via said drive plate.

4. A starting clutch apparatus according to claim 1, wherein said damper device includes a spring, said spring being of long travel type having a great displacement angle.

5. A starting clutch apparatus according to claim 1, wherein said starting clutch includes a cover and said damper device is disposed outside said cover.

6. A starting clutch apparatus according to claim 1, wherein said damper device is provided with leakage preventing means for preventing the grease of urea group from leaking out of said damper device.
